(19) United States
(12) Patent Application Publication
(10) Pub. No.: US 2002/0002477 A1
(43) Pub. Date: Jan. 3, 2002

(54) Continuing education tracking and reporting system and method

(76) Inventors: R. Barry Fox, Asheville, NC (US); J. Paul Martin, Asheville, NC (US)

Correspondence Address: Craig N. Killen, Nelson Mullins Riley & Scarborough, P.O. Box 11070, Columbia, SC, 29211, US

(21) Appl. No.: 09/803,714

(22) Filed: Mar. 9, 2001

Related U.S. Application Data
(63) Continuation of application No. 09/083,985, filed on May 22, 1998, now abandoned.
(60) Provisional application No. 60/041,494, filed on May 24, 1997.
(60) Provisional application No. 60/060,672, filed on Oct. 2, 1997.

(51) Int. Cl. G06F 17/60

(52) U.S. Cl. 705/7; 705/1

(57) ABSTRACT

A computer-based system for tracking and reporting attendance of individuals at continuing education activities and the like. One or more suitable identification devices, such as card readers, are placed at the site of the educational activity. An identification card is distributed to the each of the prospective attendees prior to occurrence of the educational activity. Upon entering the site of the educational activity, data from the identification card of each attendee is electronically recognized by the card reader. For example, a magnetically encoded card may be swiped through the card reader in a manner similar to that by which credit cards are validated. After all of the attendees have been identified in this manner, data stored in the card reader is transferred to a central computer. The data is then used to update various database files stored in the central computer. The information can then be analyzed, sorted or otherwise manipulated to generate selected attendance reports and the like.

### CROSS REFERENCE TO RELATED APPLICATIONS

This application is based on provisional application Ser. No. 60/041,494 filed in the U.S. Patent & Trademark Office (USPTO) on May 24, 1997 and provisional application Ser. No. 60/060,672 filed in the USPTO on Oct. 2, 1997, both of which are incorporated herein by reference.

### BACKGROUND OF THE INVENTION

The present invention relates to a system and method for automatically tracking and reporting the compliance of persons subject to continuing education requirements.

Individuals engaged in the various professions are often required to complete a mandated number of continuing education credits on a periodic basis. Generally, a wide variety of educational activities will be offered throughout the year. An individual's attendance at a particular education activity is often noted manually by the provider of that activity. The provider then reports attendance by the individual to the governing board or other authority. Thus, the governing board will generally have a record of the individual's progress toward the periodic requirements. Ultimately, however, it is the individual's responsibility to plan for and attend the requisite number of credits.

While the traditional system of tracking and reporting attendance has worked reasonably well, there is room for substantial improvement. This is especially true in the case of medical professionals. Physicians, for example, are required to attend a relatively large number of continuing education activities during the relevant period. Often, hospitals and other such institutions will schedule a presentation in a particular field at the same day and time each week. For example, a particular hospital may schedule a radiology conference to be held each Tuesday at noon. These conferences are often conducted as drop-ins in which the physician need not register in advance.

Drop-in conferences are very helpful to physicians in meeting their continuing education requirements. For example, the physician, in the hospital on other business, may note that such a conference is about to begin. The physician can then attend the conference over the lunch hour with very little disruption in the workday.

While convenient for the physician, tracking and reporting of attendance by individual physicians at a drop-in conference creates a significant paperwork burden for the activity provider. In addition, because there is often no preregistration at these sessions, the physician may lose track of his or her attendance. This creates difficulty for the physician in documenting attendance at conferences in order to ensure compliance with the continuing education requirements.

### SUMMARY OF THE INVENTION

The present invention recognizes various disadvantages of prior art constructions and methods. Accordingly, it is an object of the present invention to provide an improved system for tracking and reporting continuing education credits.

It is also an object of the present invention to provide a system for automatically registering the attendance of individuals at educational activities.

It is a further object of the present invention to provide a system for storing and correlating attendance by individuals at a plurality of educational activities conducted over a period of time.

Some of these objects are achieved by a system for tracking attendance of individuals at a plurality of educational activities. The system comprises at least one identification device located at a site of a respective educational activity. The identification device is operative to record presence of individuals attending the respective educational activity and generate attendance information indicative thereof. A remote computer having prior information about each of the educational activities is operative to communicate with the identification device and receive attendance information therefrom. The remote computer is further operative to update database information based on the prior information and the attendance information received from the identification device. Preferably, the remote computer will be further operative to generate predetermined reports based on the database information.

In some exemplary embodiments, each identification device comprises a card reader device operative to read a personal identification card previously assigned to the individuals in attendance at the educational activity. Preferably, the card reader device may be operative to recognize the personal identification card as valid only if a known code is present at a predetermined location in a data field thereof. In addition, the card reader device may be further operative to indicate a time at which the personal identification card is recognized for each of the individuals in attendance. The card reader device may advantageously include a printer operative to provide an attendance receipt to each of the individuals in attendance upon recognition of the personal identification card thereof. In addition, the card reader device may be operative to print a summary listing of all attendees at the educational activity so that the provider will have a “hard copy” at the site. The card reader device may further include an electronic display to show each attendee's name as it is received into the machine from the card data.

Each of the identification devices may include a local memory operative to temporarily store attendance information regarding all of the individuals attending the respective educational activity. In such embodiments, means are further provided for transmitting the attendance information as a batch from the local memory to the remote computer. Preferably, each of the identification devices transmits a unique identifier thereof as part of the attendance information. Each of the identification devices may also be capable of transmitting the attendance information as a batch after multiple educational activities.

Often, the remote computer will be accessible via Internet communication to facilitate set up of the prior information regarding the respective educational activity. The database information may also be accessible via Internet so that individuals can check progress toward compliance with continuing education requirements, or so that providers can obtain copies of the attendance reports or selected demographic information. Selected information stored in the central computer can also be sent automatically to interested parties via e-mail, if desired.

Other objects of the present invention are achieved by a method of tracking and reporting attendance of individuals at a plurality of educational activities. According to the method, each of the individuals is provided with a personal identification card. The personal identification card of each individual who attends a respective educational activity is electronically read utilizing a suitable identification device. Attendance information indicative of the individuals in attendance at the respective educational activity is electronically retained in a temporary memory. Subsequently, the attendance information is transferred to a holding file in a central computer. Contents of the holding file are electronically written into at least one predetermined database file in the central computer. For example, the predetermined database files may include attendee files, provider files, activity files and speaker files. Finally, the database files are utilized to generate selected attendance reports.

According to exemplary methodology, the identification device preferably contains an internal clock. In this case, a card read time is correlated along with a personal identification number for the individual when the card is read. In such cases, the attendance information preferably includes the card read time and personal identification number of each individual in attendance, along with an activity unique identification number and a date on which the educational activity is conducted. The attendance information may further include an identification number for the identification device. Often, a plurality of the identification devices will be used at a site where the educational activity is held. In this case, each of the identification devices functions to transmit attendance information to the central computer.

Preferably, the attendance information is transferred to the central computer as a batch. The batch may often include attendance information for more than one of the educational activities. A modem may be utilized to transfer the attendance information to the central computer.

Generally, an initial step of the method will involve electronically supplying a provider of the educational activity with an activity unique identification number. For example, the activity unique identification number may be provided via the Internet.

Other objects of the present invention are achieved by a system for tracking attendance of individuals at an educational activity. The system comprises at least one card reader device located at a site of the educational activity. The card reader device is operative to read a personal identification card previously assigned to the individuals in attendance. The card reader device then operates to generate attendance information indicative thereof, including a time at which the personal identification card is recognized for each of the individuals in attendance.

The system further includes a remote computer having prior information about the educational activity. The remote computer is operative to communicate with the card reader device and receive respective attendance information therefrom. The remote computer is further operative to update the prior information based on the attendance information received from the card reader device.

In an exemplary embodiment, at least one card reader device comprises a plurality of card reader devices located at the site of the educational activity. In this case, each of the card reader devices may preferably transmit a unique identifier thereof as part of the attendance information.

Other objects, features and aspects of the present invention are provided by various combinations and subcombinations of the disclosed elements, as well as methods of practicing same, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a diagrammatic representation of a system for tracking attendance at an educational activity in accordance with the present invention;

FIG. 2 is a perspective view of an exemplary card reader device that may be utilized with the system of FIG. 1;

FIG. 2A illustrates an attendance receipt that may be produced by the device shown in FIG. 2;

FIG. 3 is a flow chart illustrating an exemplary process by which attendance information is generated and transferred to a remote computer;

FIG. 4 diagrammatically illustrates attendance information transferred in batch from the card reader device to the central computer at selected times;

FIG. 5 diagrammatically illustrates a plurality of relational database files that may be maintained at the central computer;

FIG. 6 is a flow chart showing the process by which an activity unique identification number (AUIN) is assigned to the activity provider;

FIG. 7 is an exemplary computer screen showing the process of assigning an AUIN via the Internet as seen from the perspective of the activity provider;

FIG. 8 is an exemplary computer screen showing how an individual may check via the Internet the total number of continuing education credits earned over the relevant period;

FIGS. 9 and 10 illustrate exemplary attendance reports that may be generated with the database information stored in the central computer; and

FIGS. 11 through 14 illustrate various computer screens that may be used by an individual using a feature of the system to set goals for future educational activities.

Repeat use of reference characters in the present specification and drawings is intended to represent same or analogous features or elements of the invention.

### DETAILED DESCRIPTION OF PREFERRED EMBODIMENTS

It is to be understood by one of skill in the art that the present discussion is a description of exemplary embodiments only, and is not intended as limiting the broader aspects of the present invention, which broader aspects are embodied in the exemplary constructions.

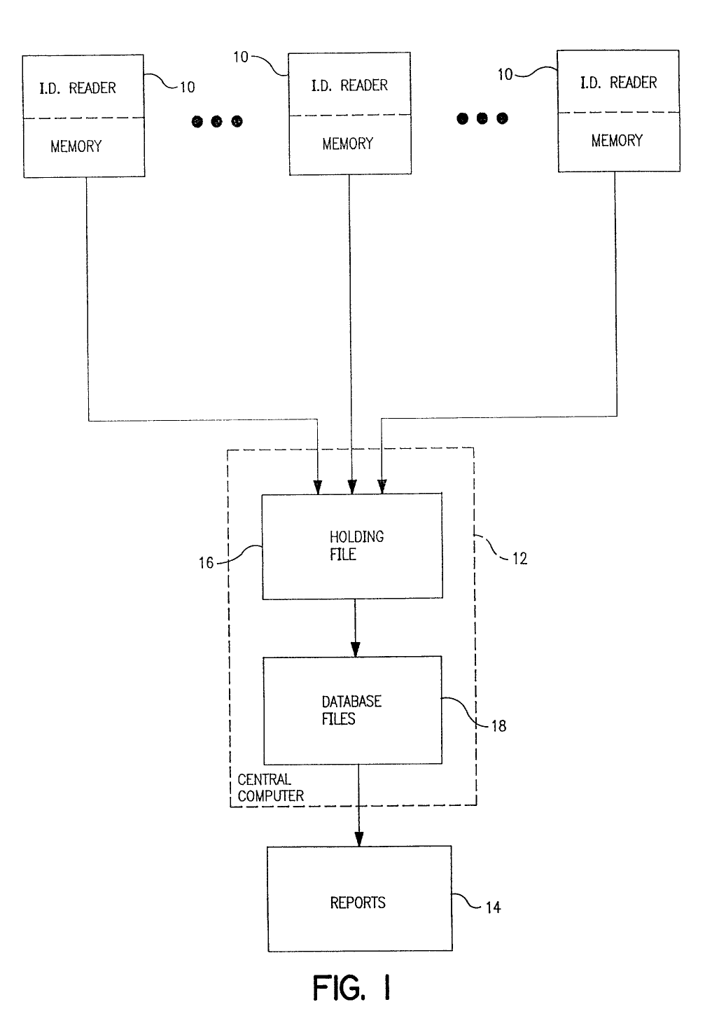

FIG. 1 illustrates the various components of a system for tracking attendance at a medical conference or other educational activity. Generally speaking, the system includes one or more identification devices 10 located at the site of the educational activity. Information collected by identification devices 10 is subsequently transferred by suitable means to a central computer 12, typically located remote from identification devices 10. Central computer 12 operates to store attendance information from a particular activity and correlate it with that collected from prior activities. As indicated at 14, suitable reports can then be generated from the database information for the use of attendees, providers of educational activities, or both.

In exemplary embodiments, each identification device will include two basic functional aspects: (1) an identification reader, and (2) a temporary memory. The identification reader generates data representative of each attendee, which is then stored in the temporary memory. At a selected time, the contents of the temporary memory are transferred to central computer 12, as noted above. In particular, the attendance information is transferred to a holding file 16 at central computer 12 to confirm transmission accuracy. The contents of holding file 16 are then passed electronically to database files 18 for storage, analysis sorting, evaluation and recording.

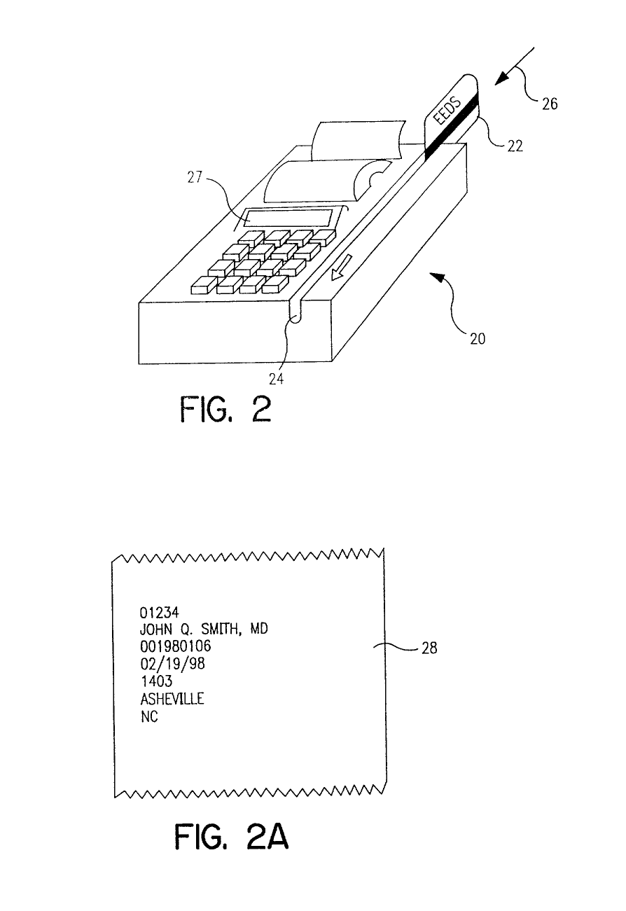

It is contemplated that various types of identity verifying machines may be utilized for identification device 10. For example, identification device 10 may be a suitable smart card reader, a bar code reader, or a machine for recognition of fingerprint and/or other anatomical features. Referring now also to FIG. 2, the illustrated embodiment utilizes a magnetic stripe card reader 20. Preferably, card reader 20 is of the same type utilized to verify credit cards at a point of purchase. Such devices are available, for example, from Verifone, Inc. of Redwood, Calif.

Where a card reader is employed, identification cards, such as card 22, are distributed to the individuals who will be expected to use the system. Like a credit card, card 22 contains a magnetic stripe having impressed data that can be read electronically. Generally, the name of the card user will also be printed on the card, as well as the name or logo of a sponsoring entity (such as “EEDS” for Electronic Education Documentation System). When the user enters the site of the educational activity, card 22 is “swiped” through slot 24, as indicated by arrow 26. The data impressed on the magnetic stripe of card 22 is thus received into card reader 20, indicating that the holder of the card is in attendance.

As is well known, the magnetic stripe of a typical wallet card has multiple data tracks. In this case, the relevant information is preferably included entirely within the seventy-nine characters of the first track. In an exemplary arrangement, the data may be ordered as follows:

| Track Position | Data |
|---|---|
| 01 | Start Sentinel |
| 02 | Format Code |
| 03-04 | State Code |
| 05-10 | Participant Identification |
| | Number |
| 11 | Field Separator |
| 12-37 | Attendee Name |
| 38 | Field Separator |
| 39-41 | Attendee Academic Degree |
| 42 | Field Separator |
| 43-48 | Attendee Date of Birth |
| 49 | Field Separator |
| 50-69 | City |
| 70 | Field Separator |
| 71-72 | Predetermined Code |
| 73-76 | Expiration Date |
| 77 | End Sentinel |
| 78 | Longitudinal Redundancy |
| | Check Character |

The data contained in locations 71-72 is a known code utilized to verify the swipe of an authentic card. In other words, if the code is not found in the specific position where it is expected, card reader 20 will presume that the card is not authentic.

Card reader 20 may have an electronic display 27 to show the name of each attendee as the card data is read into the machine. In addition, card reader 20 preferably prints a receipt 28 (FIG. 2A) after each swipe. The receipt provides information taken from the card, as well as other information regarding the particular educational activity. In the illustrated example, the following information is printed on respective lines of the receipt: (1) Participant Identification Number (PIN); (2) participant name and academic degree; (3) Activity Unique Identification Number (AUIN); (4) date; (5) swipe time; (6) city; and (7) state. The attendee keeps the receipt as evidence of attendance at the particular activity. Preferably, card reader 20 may also print a summary report giving the name and swipe time of each attendee after all attendees have entered the educational activity. This advantageously provides the activity provider with a “hard copy” attendance report at the site.

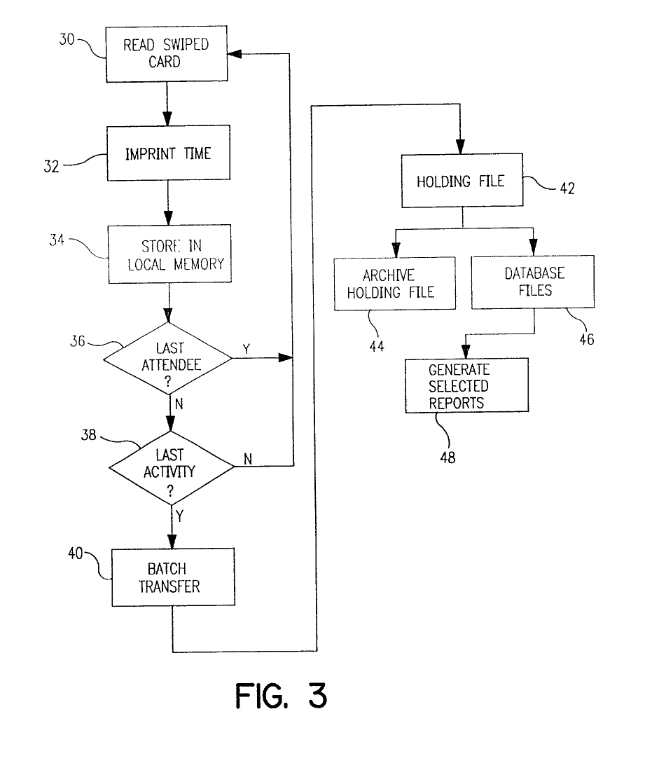

Many aspects of the attendance tracking process of the present invention can be most easily explained with reference to FIG. 3. As indicated at 30, an identification card for a respective participant is first swiped through the card reader. The data received from the swipe is electronically correlated with the time (as provided by a time clock within the card reader), as indicated at 32. Next, as indicated at 34, the combined identity and time information is stored in the card reader's temporary memory. If the card of the last attendee has not been swiped, the card reader awaits the next swipe as indicated at 36. Often, the card reader may be used for multiple activities before data is transferred from the temporary memory. The decision block at 38 indicates that additional swipes may be read until the last attendee of the last activity.

At a selected time, the provider of the educational activity will desire to transfer the contents of the temporary memory to the central computer. Preferably, as indicated at 40 and 42, this attendance information is transferred to the holding file of the central computer as a batch. While the invention contemplates transmission of the data using a variety of wired and wireless technologies, the card reader in presently preferred embodiments employs a telephone modem. At the time the transmission is to take place, a modem line is plugged into a telephone jack. The card reader is activated to dial a preprogrammed telephone number (such as a toll free number), and automatically transmit the stored information after a predetermined “handshake” has been achieved. Preferably, the data sent to the central computer is suitably encrypted during the transmission process. Instead of being sent all at one time, the data may be sent in subpackets with intervening acknowledgment signals from the central computer.

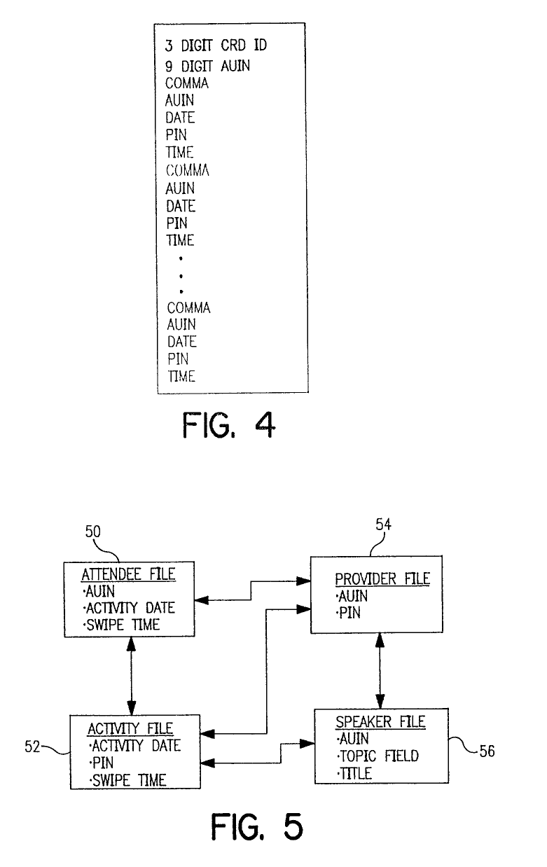

The data arrangement of the attendance information transmitted to the central computer is diagrammatically illustrated in FIG. 4. The attendance information preferably includes a “header” made up of the 3-digit identification number of the particular card reader device plus a 9-digit AUIN. In one exemplary, the nine digits of the AUIN represent the following: (1) first three digits—state code; (2) second two digits—year; and (3) last four digits—event code. A comma separates the header from the first participant data set, which includes the AUIN, the date (taken from the memory of the card reader), the PIN for the participant as read from the card, and the swipe time. The first participant data set is separated from the data set for the second participant by a comma, which is itself separated from the data set for the third participant by a comma, and so forth.

It can be seen that the swipes are transmitted in the order in which they are made into the machine. After transmitting its data, the temporary memory of the card reader is empty and retains only its original programming and the telephone number. The telephone number acts as and in fact is a default number until it is changed by keying a new number into the card reader at set-up.

Preferably, the holding file is set up by the central computer at the time the data is received. In an exemplary embodiment, the filename established for the holding file is the 3-digit identification number of the card reader device and the last five digits in the AUIN. This provides a unique file name for incoming batches and prevents overlaying of one file on another, which could happen if the file names were the same. As a result, multiple readers can be keyed in with the same AUIN and used at the same activity without conflict in programming, sending, receiving or establishing the text holding file. All information necessary to attribute the activity to individuals is contained within the comma-delineated file of the transmitted attendance information.

Referring again to FIG. 3, each holding file developed in this manner is archived for possible later use, as indicated at 44. The information contained in the holding file is also moved, as indicated at 46, into appropriate locations within the database files, such as tables, subtables, files and records. The desired reports are generated from this database information, as indicated at 48.

FIG. 5 illustrates various relational files that may be established in the database of the central computer. In this exemplary embodiment, the files established include attendee files 50, activity files 52, provider files 54 and speaker files 56. As shown, each of the files contains the various information required to keep track of multiple educational activities. The respective speaker files 56 are provided to keep track of all activities at which a particular speaker has appeared, as well as the topic that was presented at each.

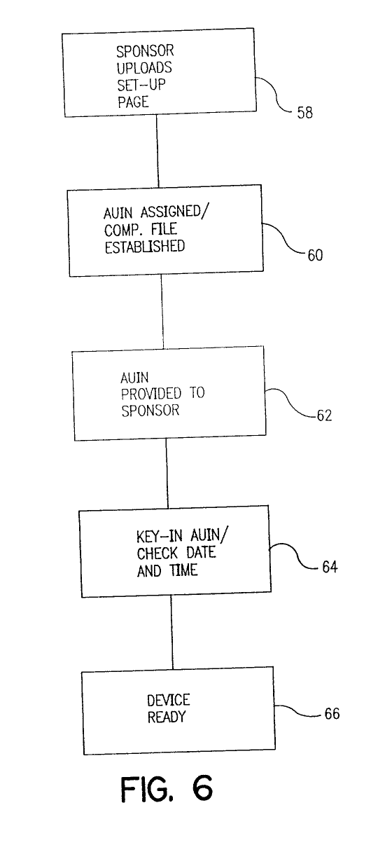

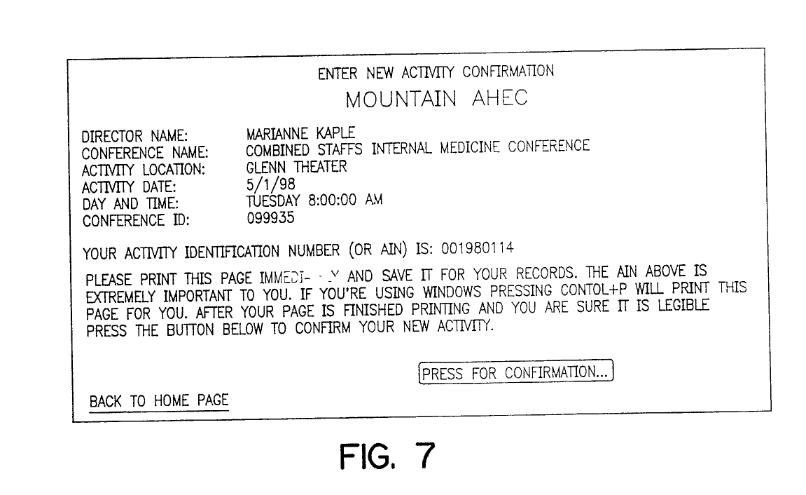

As noted above, a unique number, i.e., the AUIN, is preassigned to each of the activities for which attendance will be recorded. A preferred procedure by which the AUIN is assigned will now be explained with reference to FIGS. 6 and 7. First, as indicated at 58, personnel at the activity provider upload a set-up page via the Internet. As shown in FIG. 7, the set-up page requests certain information about the activity to be scheduled. In addition to the information shown in this example, it will often be desirable to include the name of the speaker and the general nature of the topic. Other information, such as the number of continuing education credits, may also be entered.

The AUIN is assigned by the central computer after the requisite information has been provided, as indicated at 60. Simultaneously, an “empty” database file is set up for the new activity. The assigned AUIN is also shown to the provider personnel, as indicated at 62. As indicated at 64, the AUIN is later keyed into each card reader to be used for recording attendance at the activity. When the card reader has been programmed, and diagnostically checked for correct date, time and the like, it can be used to read attendance information (as indicated at 66).

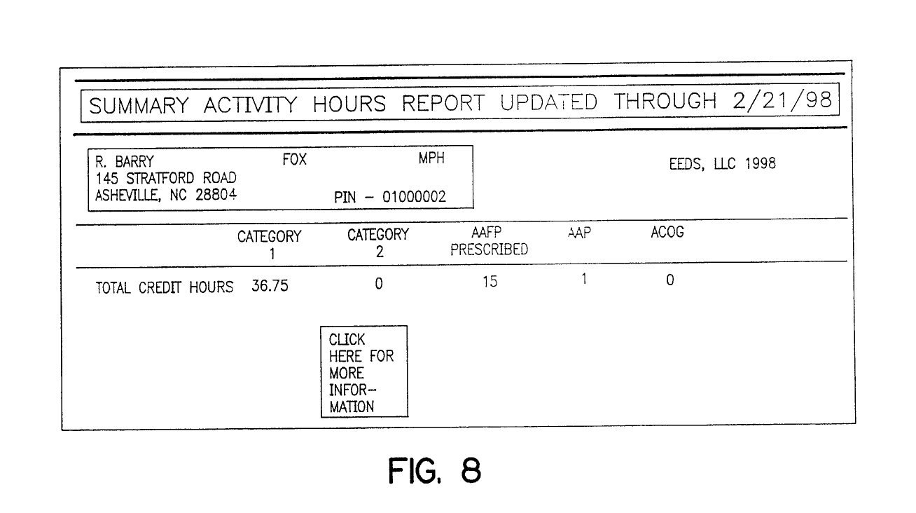

As noted above, the information in the database files can be used by the central computer to provide various types of reports. FIG. 8 illustrates a summary report screen that may be accessed via the Internet. This screen shows a participant the total of the credit hours earned to date in the relevant period. In one contemplated usage, this level of information could be provided at no charge. More detailed information, such as a detailed listing of all activities attended, may be accessed by subscribing to a fee service. The “more information” window in the screen provides details on how to subscribe to the service.

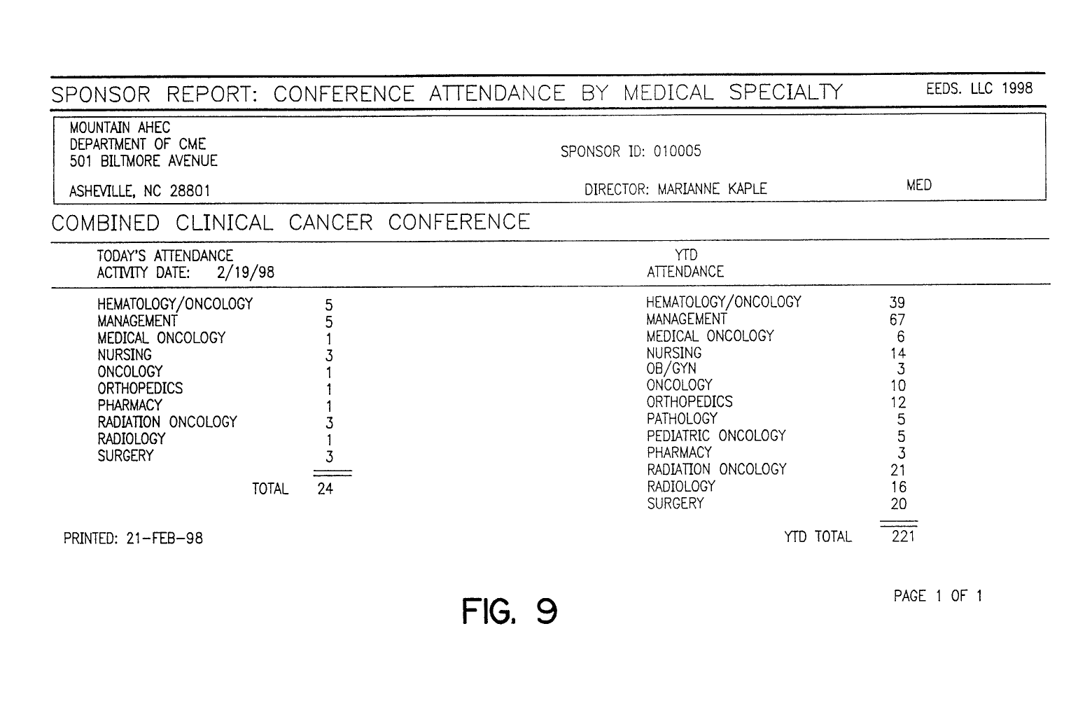

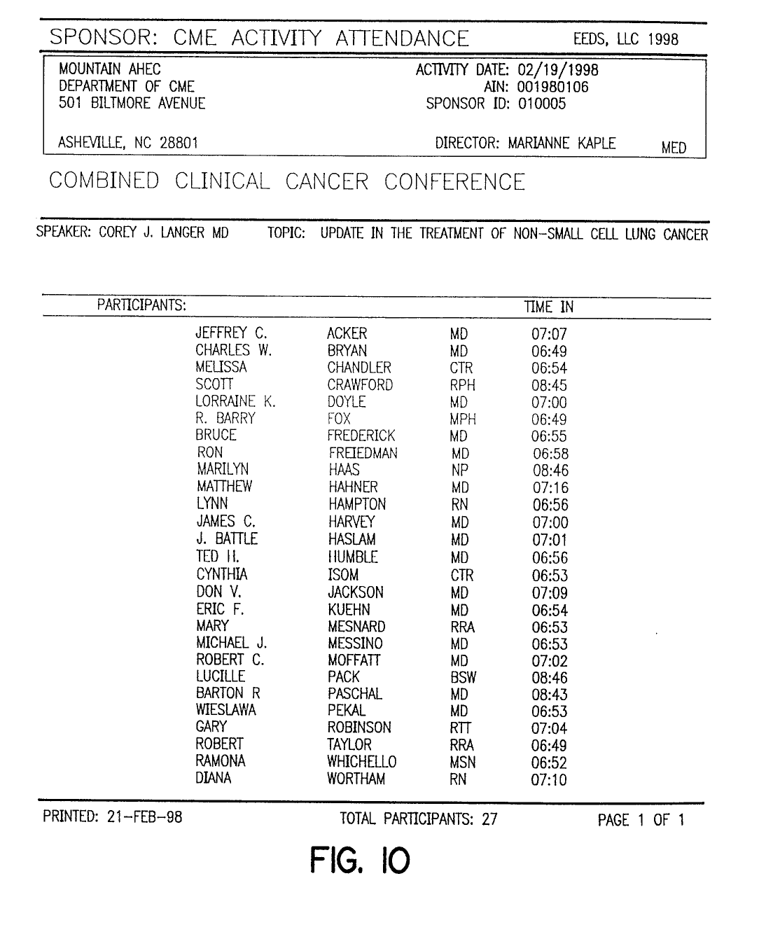

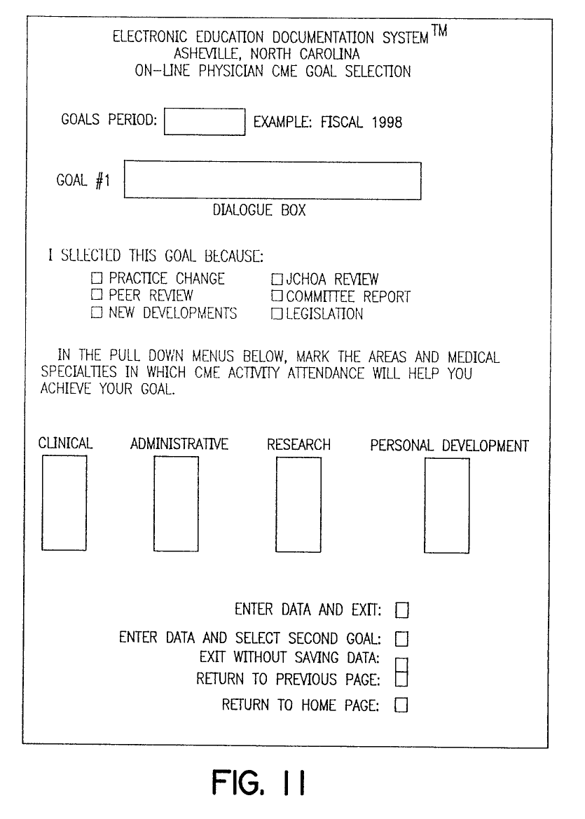

FIGS. 9 and 10 provide additional types of reports that can be generated using the database information. The report in FIG. 9 gives the provider of a particular educational activity various details of the demographics of attendees. FIG. 10 gives a list of the attendees by name, along with the time that each swiped in.

It will be appreciated that reports accessed via the Internet can be printed and/or downloaded by the viewing party as desired. The system can also be configured to automatically send selected reports to particular parties after the reports have been prepared.

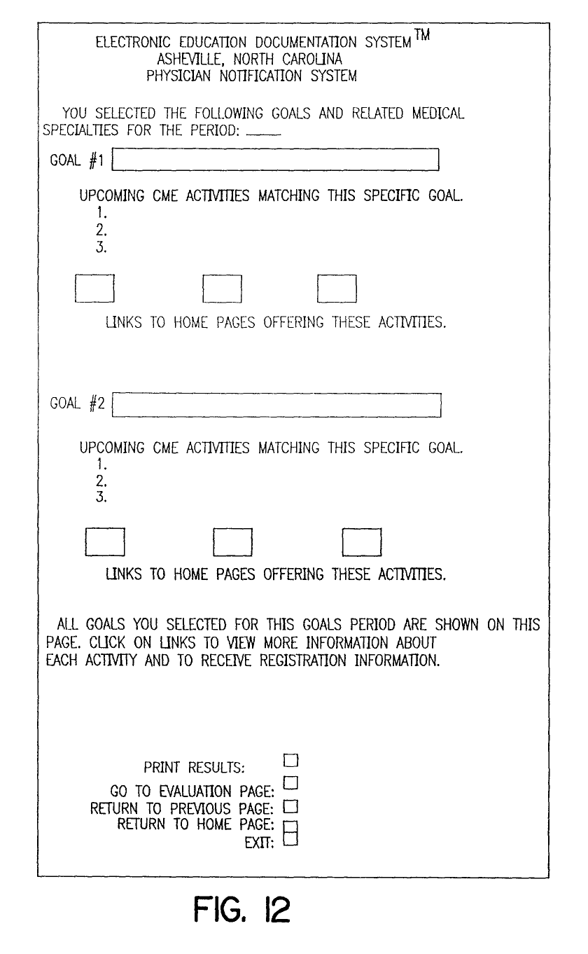

Referring to FIGS. 11-14, a further feature of the invention describes educational goal setting and evaluation by the individual for specific time periods. This and other related transactions may also be accomplished over the Internet.

For example, a physician can describe personal goals as in the screen of FIG. 11 and select medical specialties that directly relate to each of those goals. Several medical specialties can be selected for each goal in this example. These medical specialties match with the topics entered for upcoming educational activities when the AUIN is assigned.

As new educational activities are entered into the system, they are electronically reviewed for medical specialties. Messages are sent to physicians who selected that medical specialty to help them achieve desired goals during the period. The message may take the form of an automatic fax, e-mail, voice mail, or other means convenient to the individual. One form for conveying this information is shown in FIG. 12.

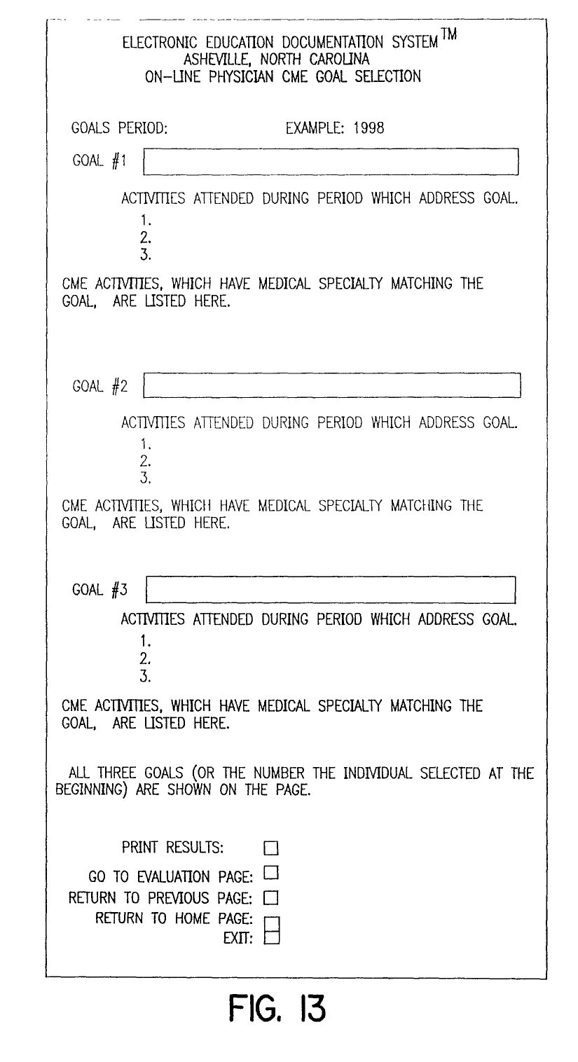

As shown in FIG. 13, at the conclusion of the goals period, the physician may access the evaluation area personally or, an additional message may be sent to the physician listing the educational activities attended during the period which address and directly relate to the stated goals. This form provides valuable documentation to assist the physician in evaluating his or her performance during the period.

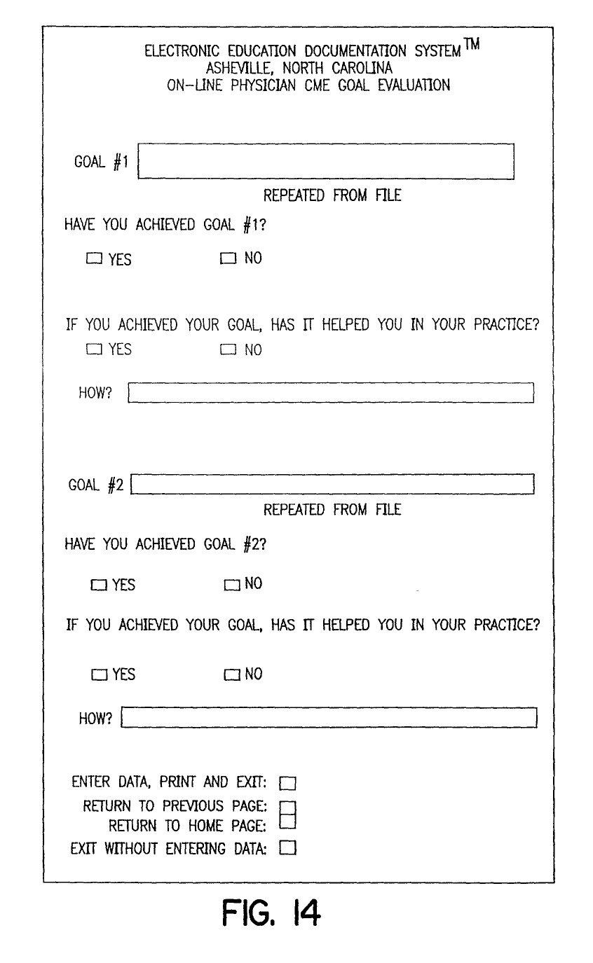

FIG. 14 describes the general form used for the physician to record a personal assessment of success during the period.

Information derived by this part of the system will be analyzed in a confidential manner to help guide CME activity development to meet physician needs.

It can be seen that the present invention provides a novel system for tracking attendance of individuals at educational activities. While various constructions are described above, one skilled in the art will appreciate that variations and modifications may be made without departing from the invention. In addition, aspects of the various embodiments may also be interchanged both in whole or in part. Furthermore, those of ordinary skill in the art will appreciate that the foregoing description is by way of example only, and is not intended to be limitative of the invention so further described in such appended claims.

What is claimed is:

1. A system for tracking attendance of individuals at a plurality of educational activities, said system comprising:
at least one identification device located at a site of a respective educational activity, said identification device operative to record presence of individuals attending the respective educational activity and generate attendance information indicative thereof;
a remote computer having prior information about each of the educational activities, said remote computer operative to communicate with said identification device and receive attendance information therefrom; and
said remote computer being further operative to update database information based on said prior information and said attendance information received from said identification device.

2. A system as set forth in claim 1, wherein said remote computer is further operative to generate predetermined reports based on said database information.

3. A system as set forth in claim 1, wherein each said identification device comprises a card reader device operative to read a personal identification card previously assigned to the individuals in attendance at the educational activity.

4. A system as set forth in claim 3, wherein said card reader device is operative to recognize the personal identification card as valid only if a known code is present at a predetermined location in a data field thereof.

5. A system as set forth in claim 3, wherein said card reader device is further operative to indicate a time at which the personal identification card is recognized for each of the individuals in attendance.

6. A system as set forth in claim 5, wherein said card reader device includes a printer operative to provide an attendance receipt to each of the individuals in attendance upon recognition of the personal identification card thereof.

7. A system as set forth in claim 1, wherein said at least one identification device comprises a plurality of said identification devices located at the site of the respective educational activity.

8. A system as set forth in claim 1, wherein each of said identification devices includes:
a local memory operative to temporarily store attendance information regarding all of the individuals attending the respective educational activity; and
means for transmitting the attendance information as a batch from said local memory to said remote computer.

9. A system as set forth in claim 8, wherein said card reader device includes a printer operative to provide a summary report of all of the individuals in attendance as stored in said local memory.

10. A system as set forth in claim 8, wherein each of said identification devices transmits a unique identifier thereof as part of the attendance information.

11. A system as set forth in claim 10, wherein each of said identification devices is capable of transmitting the attendance information as a batch after multiple educational activities.

12. A system as set forth in claim 1, wherein said remote computer is accessible via Internet communication to facilitate set up of said prior information regarding the respective educational activity.

13. A system as set forth in claim 1, wherein said database information is accessible via Internet.

14. A method of tracking and reporting attendance of individuals at a plurality of educational activities, said method comprising steps of:
(a) providing each of the individuals with a personal identification card;
(b) electronically reading said personal identification card of each of the individuals in attendance at a respective of the educational activities utilizing a suitable identification device;
(c) electronically retaining attendance information indicative of all of the individuals in attendance at the respective educational activity in a temporary memory;
(d) transferring the attendance information to a holding file in a central computer;
(e) electronically writing contents of said holding file into at least one predetermined database file in the central computer; and
(f) utilizing the database files to generate selected attendance reports.

15. A method as set forth in claim 14, wherein the identification device contains an internal clock and step (b) further involves correlating a card read time along with a personal identification number for the individual.

16. A method as set forth in claim 15, wherein the attendance information includes the card read time and personal identification number of each of the individuals in attendance, along with an activity unique identification number and a date on which the educational activity is conducted.

17. A method as set forth in claim 16, wherein the attendance information further includes an identification number for said identification device.

18. A method as set forth in claim 17, wherein a plurality of said identification devices are used at a site of the educational activity, each of the identification devices transmitting attendance information to said central computer.

19. A method as set forth in claim 14, wherein said attendance information is transferred in step (d) as a batch.

20. A method as set forth in claim 19, wherein said batch includes attendance information for more than one of the educational activities.

21. A method as set forth in claim 19, wherein the attendance information is transferred to the central computer via modem.

22. A method as set forth in claim 14, wherein said at least one predetermined database files includes an attendee file, a provider file, an activity file and a speaker file.

23. A method as set forth in claim 14, further comprising the step, prior to step (a), of electronically supplying a provider of the educational activity with an activity unique identification number.

24. A method as set forth in claim 23, wherein the activity unique identification number is provided via the Internet.

25. A method as set forth in claim 23, wherein the provider of the educational activity is required to input topic information regarding the educational activity to be held, and a message is automatically sent to interested parties based on said topic information regarding the educational activity to be held.

26. A system for tracking attendance of individuals at an educational activity, said system comprising:
at least one card reader device located at a site of the educational activity, said card reader device operative to read a personal identification card previously assigned to the individuals in attendance and generate attendance information indicative thereof, each of said card reader devices being further operative to indicate a time at which the personal identification card is recognized for each of the individuals in attendance;
a remote computer having prior information about the educational activity, said remote computer operative to communicate with the card reader device and receive respective attendance information therefrom; and
said remote computer further operative to update said prior information based on said attendance information received from said card reader devices.

27. A system as set forth in claim 26, wherein the card reader device includes:
a local memory operative to temporarily store attendance information regarding all of the individuals attending the respective educational activity; and
an internal modem operative to transmit the attendance information as a batch from said local memory to said remote computer.

28. A system as set forth in claim 27, wherein said card reader device is operative to recognize the personal identification card as valid only if a known code appears at a predetermined location in a data field thereof.

29. A system as set forth in claim 26, wherein said card reader device includes a printer operative to provide an attendance receipt to each of the individuals in attendance upon recognition of the personal identification card thereof.

30. A system as set forth in claim 26, wherein said at least one card reader device comprises a plurality of card reader devices placed at a site of the educational activity.

31. A system as set forth in claim 30, wherein each of said card reader devices transmits a unique identifier thereof as part of the attendance information.
